(19) United States
(12) Patent Application Publication
(10) Pub. No.: US 2003/0171942 A1
(43) Pub. Date: Sep. 11, 2003

(54) Contact relationship management system and method

(75) Inventor: Robert G. Gaito, Troy, NY (US)

Correspondence Address: HOFFMAN WARNICK & D'ALESSANDRO, LLC, 3 E-COMM SQUARE, ALBANY, NY, 12207

(73) Assignee: I-Centrix LLC, Albany, NY (US)

(21) Appl. No.: 10/091,956

(22) Filed: Mar. 6, 2002

(51) Int. Cl. G06F 17/60

(52) U.S. Cl. 705/1

(57) ABSTRACT

A contact relationship management system and method. The system and method generate a target list of target contacts from a contact database having a plurality of contacts. The system and method use a unique identifier to query a history database for each contact. The system and method then determine a set of history attributes for each contact based on the query, and generate the target list from the contact database based on at least one history attribute.

### BACKGROUND OF THE INVENTION

1. Technical Field

The current invention generally relates to contact relationship management. Specifically, the invention provides a system and method for generating, tracking, and managing contacts as they relate to, for example, direct marketing efforts.

2. Background Art

Many businesses process large volumes of contacts, i.e., name, address, telephone, email, etc., information for a particular individual, as a routine part of their marketing plan. One aspect of this processing frequently includes generating a list of contacts to be used, for example, in a mailing list, from a combination of prospective and current customer names.

Businesses that routinely handle large volumes of contacts include, but are not limited to: utilities, financial institutions, political parties, retailers, catalogers, and higher education institutions. Ideally, a record of each contact will be stored in a database that will later be used to evaluate the effectiveness of the marketing offer. Given the large volume of contacts, it is difficult to track each contact, let alone integrate contact information with actual sales information to measure the effectiveness of each contact. Technology has been developed over the past few years that allows businesses to generate a personal identification number (PIN) for each contact in their database. Use of a PIN allows for simplified tracking and updating of contacts. For example, an individual may change his/her name, move, etc., several times during his/her lifetime. Use of the PIN provides a static piece of data that remains associated with the individual while these other changes occur.

When a list containing potentially new contacts is presented, the marketing organization can use this PIN technology to look for a contact in its PIN database that matches the new contact. If such a contact is found, it is returned and its PIN is used. However, if a match is not found, a new PIN is assigned to the contact and it is added to the database. Matching logic may differ from business to business or industry to industry. For example, due to the laws and regulations surrounding the credit industry, very few corrections or assumptions are made when seeking a match for a perspective contact. For example, a contact with the name “J. Doe” may be presented to the system. A contact having the name “John Doe” may already be present with all other information being the same. However, in this situation a new PIN is generally assigned, and the two contacts are treated as different individuals. Other businesses can be more flexible in determining what constitutes a matching contact. Therefore, numerous rules for determining a match are possible.

PIN technologies are but one tool in the direct marketing arsenal. It allows businesses to track contacts but it does not address all of the direct marketing issues. For example, most direct marketers market to both prospects (in hopes of acquiring new customers) and existing customers (in hopes of upselling or cross-selling additional products). The process of integrating these disparate lists is often referred to the merge and purge process and results in the production of one or more target lists or mailing files.

The merge and purge process may first correct one or more data issues. For example, initially, a list of potentially new contacts may be in a format that is different from a business' internal data format. Consequently, the contact data may require reformatting to be made compatible with the existing contact data format. Additionally, corrections to the contact information may need to be made. Common corrections include, for example, mistyped street, city or state names, zip codes or individual names. The merge system can then merge the contacts into a mailing file. For example, multiple lists containing contacts may be merged into a single mailing file that includes one entry for each unique contact from the lists. In performing this, the merge system compares the data of contacts on each of the lists with the data of contacts already added to the mailing file.

A business may also need to purge contacts from its mailing file. Contacts to be purged may be in a purge list identifying contacts that should not appear in the mailing file. For example, a business may obtain a list of contacts that are on a pander list to prevent unsolicited 3rd class mail, a do not call list, or a list of recently deceased individuals. These contacts should not appear in a mailing file to be used, for example, for a new mass-mailing campaign. Similar issues regarding the formatting of data and correction of mistyped data may also arise with the purge list and can be addressed in a similar fashion as discussed above.

Businesses that produce mass mailings generally perform the merge and purge operations frequently. Using a catalog company as an example, it may rent or purchase one or more lists of contacts from another company. The contacts may then be sent with an internal list of contacts through the merge and purge system described above to produce a final mailing file containing the contacts to receive the mailing.

However, frequently, a catalog company may desire to limit the contacts in a mailing file further. For example, it may seek to only send a mailing to contacts that did not receive a catalog in the last mailing or have a target number of contacts to receive the mailing. Typically, a list of contacts from one or more previous mailing files is used as a purge list for the merge and purge system described above to produce a new mailing file.

Use of the merge and purge system in this manner is inefficient in several respects. For example, the merge and purge system may perform several textual comparisons of contact data to determine whether two contacts match. This comparison is costly in terms of time, computing resources and is also error prone due to mistyped data.

As a result, there exists a need for a system and method for integrating customer lists, prospect lists, and prior contact history in such a way that direct marketers can use this information to drive their marketing efforts.

### SUMMARY OF THE INVENTION

The invention provides a system and method for managing contacts and contact strategies. The invention assigns a unique identifier to each contact thereby allowing for efficient selection of contacts based on one or more attributes of the contacts.

A first aspect of the invention provides a method of generating a target list, comprising: creating a contact database having a plurality of contacts, wherein each contact has a unique identifier; querying a history database for each contact using the unique identifier; determining a set of history attributes for each contact based on the query; and generating the target list from the contact database based on at least one history attribute.

A second aspect of the invention provides a system for generating a target list from a plurality of input lists, each input list having a plurality of input contacts, comprising: an identification system for associating a unique identifier to each input contact; a merge system for processing the plurality of input lists to generate a contact database having a plurality of contacts; a history system for determining a set of history attributes for each contact by querying a history database for each contact using the unique identifier; and a target system for generating the target list based on the contact database and at least one history attribute.

A third aspect of the invention provides a method of creating a contact management report, comprising: creating a contact database having a plurality of contacts by merging a plurality of input lists, wherein each contact includes a unique identifier and a value indicating a number of input lists on which the contact appeared; querying a history database for each contact in the contact database using the unique identifier; specifying a previous target list based on a plurality of previous input lists; determining a set of history attributes for each contact in the contact database based on the previous target list and the query; and creating the contact management report based on the contact database, the previous target list and the set of history attributes.

A fourth aspect of the invention provides a contact management report based on a contact database and a previous target list, wherein the contact database includes a plurality of contacts merged from a plurality of input lists, and wherein the previous target list includes a plurality of target contacts merged from a plurality of previous input lists, comprising: input list data that describes at least one attribute of each input list; previous target list data that describes at least one attribute of the previous target list; group data that describes one of a group of contacts and a group of target contacts having a common history attribute; and comparison data that describes at least one history attribute of a group of contacts that match a group of target contacts and appear on both an input list and the previous target list.

The exemplary aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computer system according to one aspect of the invention;

FIG. 2 shows a data flow diagram of the computer system of FIG. 1;

FIG. 3 shows a portion of an exemplary contact management report; and

FIG. 4 shows a method of implementing the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Generally stated, the invention provides a system and method for generating, tracking, and/or evaluating one or more target lists. The system and method generate a target list based on at least one history attribute of contacts in a contact database.

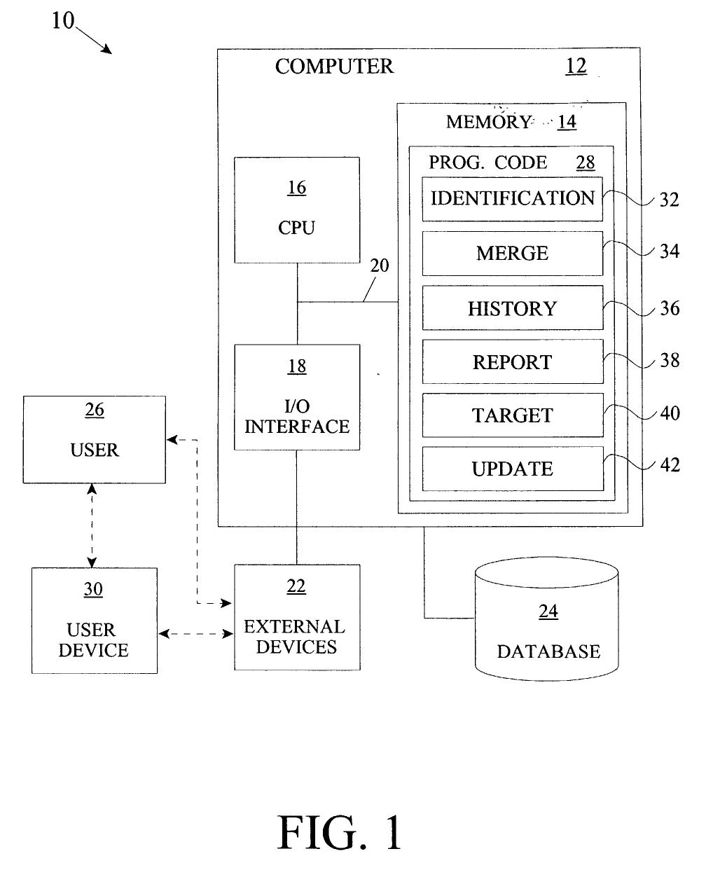

Turning to FIG. 1, a target list generation system 10 according to one aspect of the invention is shown. Target list generation system 10 generally comprises computer 12 and program code 28. User 26 can interact with computer 12 executing program code 28 to create a target list (not shown).

Computer 12 generally comprises memory 14, central processing unit (CPU) 16, input/output (I/O) interface 18 and bus 20. A database 24 may also be provided for storage of data relative to processing tasks. Memory 14 and/or database 24 may comprise any known type of data storage and/or transmission media, including magnetic media, optical media, random access memory (RAM), read-only memory (ROM), a data cache, a data object, etc. Moreover, memory 14 and/or database 24 may reside at a single physical location, comprising one or more types of data storage, or be distributed across a plurality of physical systems in various forms. Likewise, CPU 16 may comprise a single processing unit, or be distributed across one or more processing units in one or more locations, e.g., on a client and server. Computer 12 can comprise an advanced mid-range multiprocessor-based server utilizing standard operating system software, which is designed to drive the operation of the particular hardware and which is compatible with other system components and I/O controllers. I/O interface 18 may comprise any system for exchanging information with one or more external devices 22. For example, external devices 22 may comprise any known type of input/output device including an I/O port (serial, parallel, ethernet, etc.), a universal serial bus (USB) controller, a network system, modem, keyboard, mouse, scanner, voice recognition system, monitor (cathode-ray tube (CRT), liquid-crystal display (LCD), etc.), printer, disc drives, etc. Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12.

Program code 28 is shown stored in memory 14. User 26 can interact with program code 28 to create a target list. User 26 may interact with program code 28 by interacting directly with external devices 22, and/or by interacting with another computing device 30 in communication with one or more external devices 22 in a client-server environment. Computing device 30 could communicate with computer 12 via external devices 22 through, for example, a direct connection, a private network, a virtual private network (VPN), a local area network (LAN), a wide area network (WAN), etc. For example, program code 28 can execute on computer 12 that is connected to the world wide web by using one or more external devices 22. User 26 can subsequently access the world wide web using computing device 30 and interact with program code 28.

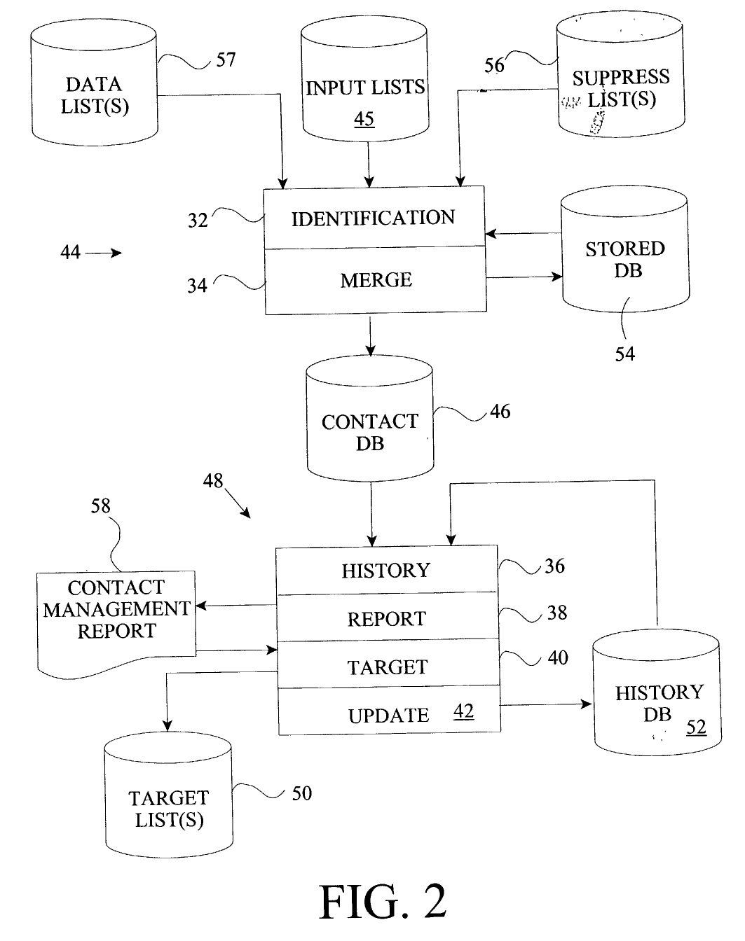

Program code 28 is shown including an identification system 32, a merge system 34, a history system 36, a report system 38, a target system 40 and an update system 42. The operation of each of these systems is further discussed with reference to FIG. 2.

FIG. 2 shows a data flow diagram of one embodiment of the invention that includes a front end system 44 and a back end system 48. As shown, front end system 44 processes a plurality of input lists 45 each having a plurality of input contacts to create a contact database 46 having a plurality of contacts. Contact database 46 is then provided to back end system 48 that generates one or more target lists 50. Each target list 50 is generated based on at least one history attribute included in a set of history attributes that is determined by back end system 48 querying a history database 52. History database can contain data on previous target contacts, previous target lists, information derived during the consumer identification process (i.e., the number of different lists on which each contact name appeared), etc. Contacts in contact database 46 are linked with data in history database 52 through the use of persistent and unique identifiers obtained by front end system 44 querying stored database 54. It is understood that a set of history attributes can include a single history attribute or a plurality of history attributes as required by a particular application.

Front end system 44 is shown including identification system 32 and merge system 34 that process the plurality of input lists 45 into contact database 46. Input lists 45 each include a plurality of input contacts and can come from any source. For example, input lists 45 can be generated by a third party who rents use of input list 45 to a company, can be based on a previous target list 50, can be generated from a stored database 54, etc.

Identification system 32 associates a unique identifier to each input contact that does not have a unique identifier. The unique identifier is any unique and persistent mechanism identifying an individual represented by the data. In some cases, input contacts on input lists 45 may already have unique identifiers. For example, an input list 45 may be a previously generated target list 50. In this case, identification system 32 can pass input list 45 on to merge system 34 without processing. In other cases, input lists 45 may be a list of contacts obtained from a third party that do not have associated unique identifiers compatible with system 10. In this case, identification system 32 can use stored database 54 to associate a unique identifier to each contact that does not have a unique identifier.

Stored database 54 has a plurality of stored contacts, each having a unique identifier. Each stored contact in stored database 54 represents a unique individual (as best can be determined) and each has a unique identifier different from all other unique identifiers in stored database 54. In operation, identification system 32 determines whether each input contact on each input list 45 matches any of the stored contacts in stored database 54. If an input contact matches any stored contact, the unique identifier of the stored contact can be associated with the input contact. More than one input contact on a particular input list 45 may be determined to match the same stored contact and thus will have the same unique identifier associated to each input contact. However, when an input contact does not match any stored contact in stored database 54, identification system 32 can generate a unique identifier for the input contact.

Identification system 34 can further add each input contact that does not match any stored contact to stored database 54.

Identification system 32 can also assign one or more additional identifiers. For example, identification system 32 may assign a group identifier that is unique to all input contacts/stored contacts having addresses that are determined to match, i.e., belonging to the same household. Numerous other groupings of individuals are possible and are equally covered under the invention.

Identification system 32 can use any of numerous standards in determining whether two data items are a match. A higher standard would require that all information in the respective data items match exactly. Conversely, it may be acceptable that the respective data items are highly similar, for example, having a single different letter, two swapped letters, etc. Additionally, contacts may be determined to match when most of the data items are determined to match and/or are identical or several key data items match and/or are identical. A user can be allowed to select and/or change a particular standard used by identification system 32 and/or subsequent systems as discussed below to determine a match.

Merge system 34 processes input lists 45 to generate contact database 46. Merge system 34 can process each input list 45 in a particular order. For example, input lists 45 can each include a priority. Merge system 34 can process the input lists 45 by starting with the highest priority, and continuing to process each remaining input list 45 in reverse order of the input lists 45 respective priorities. Merge system 34 can further determine an input list 45 having a highest priority on which each contact appeared. For example, each contact can include data identifying an input list 45 from which it was selected and added to contact database 46. By processing input lists 45 from highest priority to lowest priority as described above, the data will identify the input list 45 having the highest priority on which the contact appeared. Alternatively, merge system 34 can process each input list 45 in the order that they are selected by a user or without following a particular ordering. It is understood that any method of selecting an order of processing input lists 45 is possible and covered under the invention.

Merge system 34 determines a set of unique input contacts from input lists 45 and adds each unique input contact to contact database 46. Initially, merge system 34 can “dedup” some or all of input lists 45. Deduping input list 45 can include marking and/or removing input contacts that are determined to match another input contact on the same input list 45. Because each input contact has a unique identifier after passing through identification system 32, matching input contacts can be determined by comparing the respective unique identifiers and determining whether they are the same. Alternatively, a match can be determined by comparing data, for example, by using any method as described above with reference to identification system 32.

One or more suppress lists 56 can also be input into front end system 44. A suppress list 56 can contain a plurality of suppress contacts that should be prevented from being added to contact database 46. For example, suppress list 56 can include individuals that have expressed a desire not to be contacted, individuals who do not desire unsolicited 3rd class mail, recently deceased individuals, etc. Suppress list 56 can be an external list and may be first processed by identification system 32 and deduped as described above. Merge system 34 can ensure that each suppress contact does not appear in contact database 46. For example, prior to adding an input contact on input list 45 to contact database 46, merge system 34 can determine if the input contact is on any suppress list 56. This can be done, for example, by comparing the respective unique identifiers or by determining if the respective contacts are a match.

Should an input contact not appear on any suppress list 56 or no suppress list 56 is provided, merge system 34 can check contact database 46 to determine if the input contact matches any contact. This also can be determined, for example, by comparing the unique identifier of the input contact with the unique identifiers of contacts already in contact database 46. If the input contact does not match any contact then it can be added. If the input contact does match a contact, then the input contact may not be added. In this case, merge system 34 can determine the number of input lists on which each contact appeared by, for example, incrementing a number in a field associated with the contact that represents the number of input lists 45 on which the contact appeared.

Front end system 44 can also process one or more data lists 57. Data list 57 can include a plurality of entries that contain various information about individuals. For example, it may comprise a voter registration list, a national change of address list, a deceased list, contain demographic information about individuals such as age and income, etc. Various lists are available from numerous companies and may be rented or purchased by a company that desires to use some or all of the information. Each data list 57 can be processed by identification system 32 in a similar manner as discussed above. Merge system 34 can use data list 57 to add and/or correct information for input contacts prior to or after adding each input contact to contact database 46. Additionally, identification system 32 and/or merge system 34 can update information in stored database 54 for a stored contact to reflect data retrieved from data list 57. Alternatively, updating and/or processing of data lists 57 can be done by another system external from the invention.

The above discussion is only exemplary of the methods for creating a contact database 46 based on a plurality of input lists 45. The preceding discussion is intended to provide clarification to the invention and is not intended to limit the invention to the disclosed method. Other methods and variations of the described method can be used and are equally covered under the invention.

Contact database 46 includes a plurality of contacts, as discussed above. Each contact can include, for example, name and address information of an individual, a unique identifier as discussed above, one or more group identifiers as discussed above, a number of input lists on which the contact appeared, an input list from which the contact was selected, one or more flags indicating whether or not each name matched a suppression list or a pander list, etc. Each of these attributes can be stored as an individual and/or as a group (i.e., household). Other data, such as political affiliation, age, gender, etc. may also be included for certain applications.

Once front end system 44 has completed processing input lists 45, contact database 46 can be provided to back end system 48 to generate one or more target lists 50. Back end system 48 can include a history system 36, a report system 38, a target system 40 and an update system 42. Back end system 48 queries history database 52 for each contact using the unique identifier and determines a set of history attributes for each contact based on the query. Back end system 48 then generates one or more target lists 50 from contact database 46 based on one or more of the history attributes. For each contact identified by a unique identifier, the set of history attributes can include, for example, each previous target list on which the contact appeared, a number of input lists on which the contact appeared for a particular target list, etc.

History system 36 can easily determine a set of history attributes for each contact based on querying history database 52 by using the unique identifier of each contact. For example, by comparing unique identifiers, one or more previous target lists 50 can be examined to determine whether a current contact appeared on any of the previous target lists 50. Additionally, a previous target list 50 may have been generated by a plurality of previous input lists. In this case, the set of history attributes for contacts that appeared on a previous target list 50 can further include the number of previous input lists 45 on which the current contact appeared when the previous target list 50 was generated.

This process is greatly facilitated by using and maintaining the unique identifiers. Namely, history system 36 only needs to compare the unique identifier of the current contact with history database 52 to collect all history attributes for the contact. Without the unique identifiers, an expensive and frequently inaccurate text comparison would be required to determine a match, as described above with regard to front end system 44. In addition to the unique identifiers, group identifiers can also be used to assist in efficiently searching for data by groups of contacts that share one or more attributes. For example, using group identifiers that identify households, as described above, can allow for an efficient search to determine the last time any contact in the household received a mailing.

Target system 40 generates one or more target lists 50 based on contact database 46 and at least one history attribute. For example, a user may want each contact in contact database 46 that did not appear on a previous target list to be added to a target list 50. Alternatively, a user may want to generate target lists 50 based on the number of input lists, etc. Target system 40 can further allow a user to base target lists 50 on one or more contact management reports 58.

Report system 38 can be included to generate contact management report 58 based on contact database 46 and one or more previous target lists 50. For example, report system 38 can query history database 52 for each contact on contact database 46 using the unique identifier of each contact. Report system 38 can then determine a set of history attributes for each contact based on one or more specified previous target lists 50 and the query. Report system 38 can create contact management report 58 based on contact database 46, one or more specified previous target lists 50 and the set of history attributes. Target system 40 can further allow a user to analyze contact management report 58 and base one or more target lists 50 on contact management report 58. For example, target system 40 can select a group of contacts having at least one common history attribute based on contact management report 58 and add each contact in the group to one or more target lists 50. Target system 40 can generate a printed contact management report 58 and/or an electronic version of contact management report 58. An electronic version of contact management report 58 can include capabilities to allow a user to easily select contacts based on the data. For example, contact management report 58 can include links that allow a user to select a particular piece of data and add the contacts that comprise the data to one or more target lists 50.

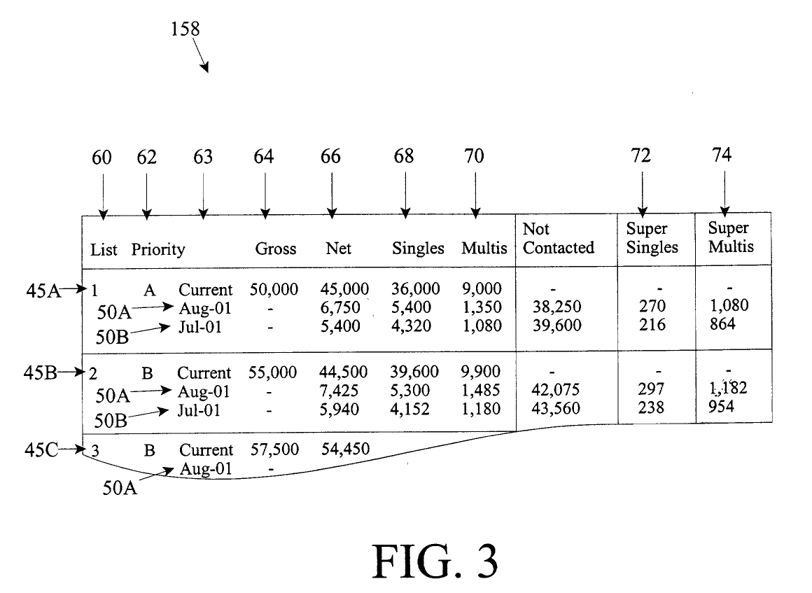

Contact management report 58 contains data derived from contact database 46 and history database 52. For example, FIG. 3 shows a portion of an exemplary contact management report 158. Contact management report 158 is based on a contact database having contacts processed from input lists 45A, 45B, 45C. Additionally, data from previous target lists 50A, 50B is based on querying history database 52 and is also shown included. Contact management report 158 is shown having three sections of data that each compare an input list 45A-C with each prior target list 50A-B.

Contact management report 158 is shown including data that describes one or more attributes of each input list 45A-C. For example, column 60 includes an input list name or identifier, column 62 includes a priority for an input list, and column 66 includes a count of the total unique input contacts obtained from an input list. This data can be stored and obtained in contact database 46. For example, each contact can have a data field that identifies an input list from which the contact was selected. In this case, contact database 46 can be queried to determine a number of contacts having a certain value for an input list name or identifier. Column 64 includes a count of the total input contacts on each input list 45A-C. Contact database 46 can contain a table that includes data about each input list, for example, an input list name, an input list priority, a total input contact count, etc. Alternatively, each contact can include some or all of this information as part of its data. For example, each contact can include a count of the number of input entries that were determined to match on an input list. Other methods of storing and retrieving data are possible and are equally covered by the invention.

Contact management report 158 is shown further including previous target list data that describes at least one attribute of each previous target list 50A-B. For example, column 63 includes a date on which each previous target list 50A-B was generated. This data can be stored and obtained, for example, in history database 52. Additionally, column 66 includes a number of target contacts for each previous target list 50A-B that appear on each input list 45A-C. This data can be obtained, for example, by querying history database 52 for a number of target contacts on a previous target list 50A-B, having a unique identifier that matches a unique identifier of any contact in contact database 46 that came from input list 45A, 45B, or 45C.

Contact management report 158 is shown further including group data that describes a group of contacts or a group of target contacts having at least one common history attribute. For example, contact management report 158 can include column 68 which includes a number of contacts or target contacts obtained from input list 45A-C or a previous target list 50A-B that appeared on a single respective input list when the contact database or previous target list 50A-B was generated. Similarly, contact management report 158 can further include column 70, which includes a number of contacts from an input list 45A-C or a previous target list 50A-B that appeared on a plurality of respective input lists 45 when contact database 46 or previous target list 50A-B was generated.

Contact management report 158 can also include comparison data that compares at least one history attribute of a group of contacts that match a group of target contacts and appear on both a contact list 46A-C and a previous target list 50A-B, respectively. A match can be determined by comparing unique identifiers of contacts and target contacts. For example, contact management report 158 can include column 72 which includes a number of the group of contacts that appeared on a single input list 45A-C in contact database 46 and multiple previous input lists 45 for a previous target list 50A-B. Additionally, column 74 can show a number of the group of contacts that appeared on multiple input lists 45 for both contact database 46 and a particular previous target list 50A-B.

Returning to FIG. 2, target system 40 can use contact database 46, history database 52 and/or contact management report 58 to more effectively generate target lists 50. For example, a mail order company may seek to generate target lists 50 to be used in an upcoming mailing. The company may purchase several input lists 45 and process them to create contact database 46 as discussed above. Generally, contacts in contact database 46 that appear on more than one input list 45 are considered to be more likely to make a purchase. Consequently, if the company seeks to make an effective target list 50, it may eliminate contacts in contact database 46 that appeared on a single input list 45.

However, after querying history database 52 and/or creating contact management report 58, the company can determine contacts in contact database 46 that appeared on a single input list 45, but were on a plurality of previous input lists when a specified previous target list was generated (as shown by column 72 of contact management report 158 in FIG. 3.) For example, a previous mailing generated during the same season of a previous year can be specified as a previous target list. These contacts may be more likely to purchase, and therefore can be included on one or more target lists 50 to be generated. This can increase the effectiveness of the mailing, thereby increasing its profitability.

Update system 42 can be included to update history database 52 based on one or more of target lists 50 generated by back end system 48. For example, each target contact on a specified target list 50 can be updated in history database 52. Additionally, a separate table including information on previous target lists can be updated to include information on one or more of target lists 50 that have just been generated.

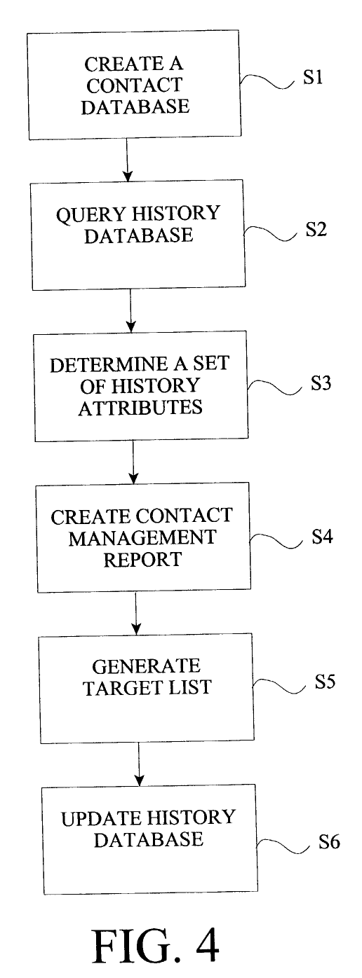

FIG. 4 shows a method of implementing the invention. In particular, a contact database is created in step S1. The contact database can be based on a plurality of input lists, any number of suppress lists and delete lists, and a stored database for associating unique identifiers to each contact. Next, a history database is queried in step S2. Based on the query, a set of history attributes can be determined in step S3. Using the set of history attributes and the contact database, a contact management report can be created in step S4. The contact management report can include data obtained from the history database on one or more previous target lists. This data can then be used, along with the contact database to generate a target list in step S5. Finally, when desired, the history database can be updated based on a target list in step S6.

It is understood that the various systems previously discussed are presented in this manner for clarity, and can be implemented in any combination and configuration. The various systems of program code 28 shown in FIGS. 1 and 2 can be implemented on separate computers and/or combined into fewer systems. Additionally, the functions provided by each system can be combined or rearranged among systems without departing from the invention. It is further understood that data discussed as being stored in a database, a list, a file, etc. and retrieved using a query, etc. can be stored and retrieved using any method now known or later developed. Use of these terms is not intended to limit the invention to storing and/or accessing data using these methods and is used solely as an exemplary implementation, and for purposes of clarity.

In the previous discussion, it is understood that the method steps discussed can be performed by a processor, such as CPU 16 of computer 12, executing instructions of a program product (for example, program code 28) stored in memory 14 as shown in FIG. 1. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which, when loaded in a computer system, is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of generating a target list, comprising:
creating a contact database having a plurality of contacts, wherein each contact has a unique identifier;
querying a history database for each contact using the unique identifier;
determining a set of history attributes for each contact based on the query; and
generating the target list from the contact database based on at least one history attribute.

2. The method of claim 1, further comprising updating the history database based on the target list.

3. The method of claim 1, wherein the creating step includes:
providing a plurality of input lists, each input list having a plurality of input contacts;
associating a unique identifier to each input contact that does not have a unique identifier;
determining a set of unique input contacts in the input lists; and
adding each unique input contact to the contact database.

4. The method of claim 3, wherein the creating step further includes determining a number of input lists on which each unique input contact appears.

5. The method of claim 3, wherein each input list further includes a priority and wherein the creating step further includes determining an input list having a highest priority on which each contact appeared.

6. The method of claim 3, wherein the associating step includes:
providing a stored contact database having a plurality of stored contacts, wherein each stored contact has a unique identifier;
determining whether each input contact matches any stored contact;
using a unique identifier for a stored contact for each input contact that matches the stored contact; and
generating a unique identifier for each input contact that does not match any stored contact.

7. The method of claim 6, wherein the associating step further includes adding each input contact that does not match any stored contact to the stored contact database.

8. The method of claim 1, wherein the creating step includes:
providing a suppress list, having a plurality of suppress contacts; and
ensuring that each suppress contact does not appear on a contact list.

9. The method of claim 1, wherein the determining step includes:
identifying a previous target list generated by a plurality of previous input lists;
determining whether each contact appeared on the previous target list; and
determining, for each contact that appeared on the previous target list, a number of previous input lists on which the contact appeared.

10. The method of claim 1, wherein the generating step includes:
identifying a previous target list;
creating a contact management report based on the contact database and the previous target list;
selecting at least one group of contacts having a common history attribute based on the contact management report; and
adding each contact in the at least one group of contacts to the target list.

11. A system for generating a target list from a plurality of input lists, each input list having a plurality of input contacts, comprising:
an identification system for associating a unique identifier to each input contact;
a merge system for processing the plurality of input lists to generate a contact database having a plurality of contacts;
a history system for determining a set of history attributes for each contact by querying a history database for each contact using the unique identifier; and
a target system for generating the target list based on the contact database and at least one history attribute.

12. The system of claim 11, further comprising an update system for updating the contact history database based on the target list.

13. The system of claim 11, further comprising a report system for generating a contact management report based on the contact database and a previous target list, wherein the target list is further based on the contact management report.

14. A method of creating a contact management report, comprising:
creating a contact database having a plurality of contacts by merging a plurality of input lists, wherein each contact includes a unique identifier and a value indicating a number of input lists on which the contact appeared;
querying a history database for each contact in the contact database using the unique identifier;
specifying a previous target list based on a plurality of previous input lists;
determining a set of history attributes for each contact in the contact database based on the previous target list and the query; and
creating the contact management report based on the contact database, the previous target list and the set of history attributes.

15. The method of claim 14, wherein the determining step includes determining a number of previous input lists on which each contact appeared.

16. A contact management report based on a contact database and a previous target list, wherein the contact database includes a plurality of contacts merged from a plurality of input lists, and wherein the previous target list includes a plurality of target contacts merged from a plurality of previous input lists, comprising:
input list data that describes at least one attribute of each input list;
previous target list data that describes at least one attribute of the previous target list;
group data that describes one of a group of contacts and a group of target contacts having a common history attribute; and
comparison data that describes at least one history attribute of a group of contacts that match a group of target contacts and appear on both an input list and the previous target list.

17. The contact management report of claim 16, wherein the input list data includes a number of contacts obtained from an input list.

18. The contact management report of claim 16, wherein the previous target list data includes a number of target contacts that appear on an input list.

19. The contact management report of claim 16, wherein the group data includes a number of contacts that appear on a single input list.

20. The contact management report of claim 16, wherein the group data includes a number of the group of contacts that appear on multiple input lists.

21. The contact management report of claim 16, wherein the comparison data includes a number of the group of contacts that appear on a single input list and a plurality of previous input lists.

22. The contact management report of claim 16, wherein the comparison data includes a number of contacts that appear on a plurality of input lists and a plurality of previous input lists.
